(19) United States
(12) Patent Application Publication
(10) Pub. No.: US 2026/0003780 A1
(43) Pub. Date: Jan. 1, 2026

(54) Memory Bit Correction Via Bit Addressing

(71) Applicant: TEXAS INSTRUMENTS INCORPORATED, Dallas, TX (US)

(72) Inventors: Giuseppe Rizzi, Dallas, TX (US); Christopher White, Plano, TX (US); Daniel R. Burggraf, Parker, TX (US)

(21) Appl. No.: 18/758,790

(22) Filed: Jun. 28, 2024

(51) Int. Cl. G06F 12/02

(52) U.S. Cl. CPC G06F 12/0246

(57) ABSTRACT

Systems and methods to address and correct individual bits within a data word in memory are disclosed. A data word may correspond to a set of additional bits. Logic in a memory controller may be configured to write a code into the additional bits in the event that a bit within the data word is slow to erase or slow to program. A subsequent read operation may then read the data word as well as the additional bits and correct the particular bit in accordance with the code stored to the additional bits.

### TECHNICAL FIELD

The present disclosure relates generally to correction of one or more bits in a memory device and, more specifically, to memory bit correction of a word using additional bits that identify a bit within the word.

### BACKGROUND

A flash memory device may include a multitude of rows, where each of those rows corresponds to a word. An individual word may include, e.g., 64 bits. The bit cells, each of which corresponds to a bit, may have undesirable operation due to voltage, temperature, process variation, and the like. For instance, for flash memory, some bits may be difficult to change from a binary zero state to a binary one state.

One attempt to address difficult bits is to use error correction code (ECC) bits. An ECC code may be derived through a hashing function of an entire word. In other words, the ECC code may depend on every bit value. In the event that a particular bit cell fails to transition from a binary zero state to a binary one state, when the word and the ECC code are read, the word and ECC code may be processed to generate a corrected word.

However, ECC techniques have some downsides. For instance, ECC codes may not be amenable to byte-level programming (or to any type of programming smaller than the bit-length comprehended by the ECC algorithm in-use). Rather, a change to an ECC code may require an erase operation, and an erase operation in flash usually affects a sector (i.e., multiple rows). As a result, when using ECC, a change to a given word (from byte programming for instance) may require a change to the ECC code which may require a sector erase. Sector erase operations may be undesirable due to various factors, such as time to erase, effect on life of the memory device, and the like.

It would be desirable to have a bit correcting technique that is accurate and flexible.

### SUMMARY

In one embodiment, a memory controller is configured to: perform a first operation to change a first value of a data word that is stored in a memory device; perform a verification operation to determine whether the first operation was successful; and in response to the verification operation, write a second value in further bits in the memory device, wherein the further bits in the memory device identify an address of a first bit within the data word.

In another embodiment, a computing device includes: a processor core; a memory device, coupled to the processor core, and configured to store a plurality of data words; a memory controller, coupled to the memory device and the processor core, and configured to perform read, write, and erase operations with respect to the memory device and under control of the processor core, further wherein the memory controller is configured to: perform an erase operation on a first data word of the plurality of data words; determine that a first bit within the first data word has not erased; and program additional bits of the memory device to identify an address, within the first data word, corresponding to the first bit.

In yet another embodiment, a method includes: programming a first value into a data word in a memory device, wherein the first value overwrites a second value, further wherein the second value includes a first bit, and wherein additional bits in the memory device identify an address within the data word of the first bit; determining whether the first value is consistent with the additional bits; and either programming the additional bits or not programming the additional bits based at least in part on the determining.

### BRIEF DESCRIPTION OF THE DRAWINGS

Having thus described the invention in general terms, reference will now be made to the accompanying drawings, wherein:

FIG. 1 is a block diagram of an example implementation of a SoC, according to various embodiments.

FIG. 2 is an illustration of an example flash controller, according to various embodiments.

FIG. 3 is an illustration of an example row of a memory device, which may be implemented in one of the banks of the example of FIG. 2, according to various embodiments.

FIG. 4 is a table that provides examples of data that may be stored in correction bits in the example of FIG. 3, according to various embodiments.

FIG. 5 is an illustration of example method for erasing a word, such as an example word of FIG. 3, according to various embodiments.

FIG. 6 is an illustration of example method for reading a word, such as an example word of FIG. 3, according to various embodiments.

FIG. 7 is an illustration of example method for programming a word, such as an example word of FIG. 3, according to various embodiments.

FIG. 8 is an illustration of an example method for correcting a bit in a word, according to various embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

A memory device may include a set of data bits and an additional set of bits used to verify the set of data bits and/or to correct errors therein. Various embodiments use the additional bits in the memory device to record a data bit where the corresponding memory cell (e.g., bit cell) is slow to erase, where those additional bits may be used to identify an address of the particular bit within an accompanying word. For instance, a 128-bit word may have a single bit cell that is slow to transition from a binary zero state to a binary one state. In this example, that bit may be bit 121 in a set [0 . . . 127]. The additional bits may be programmed to store a code, where the code may identify that bit position (e.g., bit 121). A subsequent read operation may then read the word, including the incorrect bit 121, use the additional bits to identify and correct the incorrect bit, and output a word in which all 128 bits are correct. In contrast to some ECC codes, the code stored in the additional bits of the present example identifies the specific failing bit cell, thus allowing the data to be corrected, which is not possible with some ECC codes that save space by offering error detection without error correction.

One particular use case relates to erase operations. In an example flash memory embodiment, the erase operation includes changing all the bit cells to attain a binary one state. Put another way, the erase operation may cause the bit cells in a given sector to store all 1s. However, looking at one particular word, it may include two bit cells that are slow to erase, resulting in two binary zero states within the 128 bit word, where the remainder of the bit cells store binary ones. The flash controller may perform an erase verify operation, which identifies the two zeros and, in response, performs another erase operation. The subsequent erase operation may result in all of the bit cells in the word storing binary ones. However, in a counterfactual, one of the slow to erase bit cells maintains a binary zero state, despite the multiple erase operations.

Continuing with the example, the flash controller may perform another erase verify operation to identify that there is a single remaining bit cell in a binary zero state in the word. The flash controller may then program a code into additional bits to identify that bit position (e.g., an address of the bit) within the word with a slow to erase bit cell. As noted above, a subsequent read operation may then read the correct value (all 1s).

The memory device may experience multiple operations over the life of the device, and the particular word in this example may be programmed or erased multiple times subsequently. The additional bits may be changed or not changed, depending upon the subsequent operations that are performed. Nevertheless, should an operation result in a change of the code in the additional bits, the code may be programmed into the additional bits without erasing the additional bits. As noted above, an erase operation may employ an entire sector erase. By contrast, programming the additional bits may be performed using word-level or byte-level programming and without employing a sector erase. Put another way, the additional bits may be programmed with a granularity less than what would be used by the ECC algorithm.

Various embodiments may provide advantages over other solutions. For instance, as noted above, the additional bits may be programmed using byte-level programming. This is different from ECC bits, which may employ an erase operation to change the ECC bits. An erase operation may be slower than byte-level programming, and it may cause additional wear on the device due to being performed on an entire sector. In other words, various embodiments may be faster and have less effect on a life of a memory device.

Additionally, the hardware logic used to implement addressing of individual bits within a data word and to correct those individual bits may be simpler than ECC hardware logic. As a result, various embodiments may be faster than ECC embodiments and may be more efficient of semiconductor area.

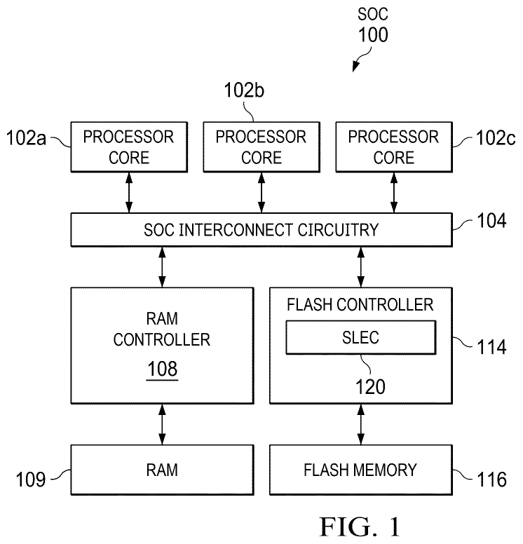

FIG. 1 is a block diagram of an example implementation of a system on-chip (SoC). The example of FIG. 1 includes an example SoC 100, example random access memory (RAM) 110, and example flash memory 116. The example SoC 100 includes example processor cores 102A, 102B, 102C (collectively, processor cores 102), example SoC interconnect circuitry 104, example RAM controller circuitry 108, and example flash controller 114. Example SoCs configured in accordance with the examples described herein may be used for any purposes and applications. In some examples, the SoC 100 may be used in automotive applications.

The example processor cores 102 execute machine readable instructions to run one or more software applications. Some of the instructions may be stored in the flash memory 116 and retrieved via flash controller 114. Accordingly, in examples described herein, the processor cores 102 may execute one or more software applications that use read operations and write operations to communicate with the example flash memory 116.

The example processor cores 102 may be implemented in any form of processor circuitry. Example processor circuitry may include, but is not limited to, programmable microprocessors, Field Programmable Gate Arrays (FPGAs), Central Processor Units (CPUs), Graphics Processor Units (GPUs), Digital Signal Processors (DSPs), microcontrollers and integrated circuits such as Application Specific Integrated Circuits (ASICs), etc. In some examples, one or more of the example processor cores may be implemented by a different type of processor circuitry from the remaining processor cores. While FIG. 1 illustrates three processor cores 102A, 102B, 102C, the example SoC 100 may include any appropriate number of processor cores.

The example SoC interconnect circuitry 104 enables the transfer of data between various components in the example SoC 100. For example, the example processor core 102A may send one or more operations to the flash controller 114 via the SoC interconnect circuitry 104. In turn, the flash controller 114 may respond to the processor core 102A via the example SoC interconnect circuitry 104. The example SoC interconnect circuitry 104 may be implemented by communication buses and/or networks to facilitate data transfer. In some examples, the example SoC interconnect circuitry 104 may enable other data transfer between components of the SoC 100 in addition to the data transfers that are explicitly illustrated in FIG. 1.

In some implementations, the flash memory 116 may be implemented off-chip, and the processor cores 102 may execute code from the flash controller 114 using an execute in place (XIP) technique. In such implementations, the SoC 100 plus flash memory 116 (when external) collectively are a system. In other implementations, such as that illustrated here, the flash memory 116 may be included on-chip. The scope of implementations is not limited to any particular on-chip or off-chip design for the flash memory 116.

The example RAM controller circuitry 108 manages the transfer of data to and from the example RAM 110. For example, the RAM controller circuitry 108 may receive a request from the example processor core 102C via the example SoC interconnect circuitry 104 to read data from or write data to the example RAM 110. Based on the request, the example RAM controller circuitry 108 may transfer requested data from the example RAM 110 to the example processor core 102C via the example SoC interconnect circuitry 104 or transfer provided data to the example RAM 110.

The example RAM 110 is an amount of volatile memory that is internal or external to the example SoC 100. The example core 102C may use the example RAM 110 when executing machine readable instructions that do not involve the example flash memory 116. In some examples, the example RAM may be implemented by double data rate (DDR) RAM to increase communication speeds with the example SoC 100. Although not shown in FIG. 1, interconnect circuitry 104 may be communicatively coupled to peripheral interfaces, such as interfaces for wireless communication and the like, thereby allowing cores 102 to communicate with peripherals.

The example flash controller 114 manages data transfer to and from the example flash memory 116. For example, the flash controller 114 may receive an operation from one of the processor cores 102 via the SoC interconnect circuitry 104 to read data from or write data to the flash memory 116. Based on the operation, the example flash controller 114 may transfer data that composes the operation to the example flash memory 116. In response to transferred operation data, the example flash controller 114 may also receive data from the flash memory 116 and transfer the response data to the processor cores 102 via the example SoC interconnect circuitry 104.

The example flash controller 114 may operate in a read mode used to send read operations to the flash memory 116 and receive data in response to the read operations. The flash controller 114 may operate in a write mode to transmit updates or other write data to the flash memory 116. The flash controller 114 may be required to switch between modes to transmit both read requests and write data.

The flash memory 116 is an amount of non-volatile memory that supports read, write, and erase operations. For example, the flash memory 116 may include a Serial NOR flash device or other appropriate flash technology. The flash memory 116 may send and receive data with the flash controller 114 using a communication standard that supports one or more protocols. For example, the flash memory 116 and flash controller 114 may use the Octal Serial Peripheral Interface (OSPI) standard or other appropriate protocol to communicate. The flash memory 116 may be implemented with or without read while write (RWW) functionality. In some examples, the flash memory 116 may be implemented in an electronic control unit (ECU) of a vehicle. In such examples, the processor cores 102 may implement software applications that write data to the flash memory 116 to update the ECU.

The flash controller 114 may receive a plurality of requests from the processor cores 102. Some requests made by the processor cores 102 may come from a software application and include write operations to the flash memory 116. At the same time, other requests made by the processor cores 102 may come from other software applications and include read operations. Some of the read related requests may correspond to real time (RT) software applications, while other XIP related requests may correspond to non-RT software applications. As used herein, an RT software application refers to a software application that performs operations with critically defined time constraints. However, the scope of implementations is not limited to either RT or non-RT applications.

Further in this example, flash controller 114 includes slow erase correction (SLEC) hardware logic 120. The SLEC hardware logic 120 may perform operations, such as are described in more detail with respect to FIGS. 3-8. For instance, SLEC hardware logic 120 may identify a bit that has an incorrect state and may further program additional bits to include information identifying an address of that bit. The flash controller 114 may read and process the additional bits during a read operation to provide corrected output.

SOC 100 may be built on a semiconductor die, which is included in a semiconductor package. In an example in which flash memory 116 may be included off-chip, the flash memory 116 may include its own semiconductor die and may be included in a same or a different semiconductor package as the SOC 100. The scope of implementations may be adapted to any appropriate arrangement of dies and packages.

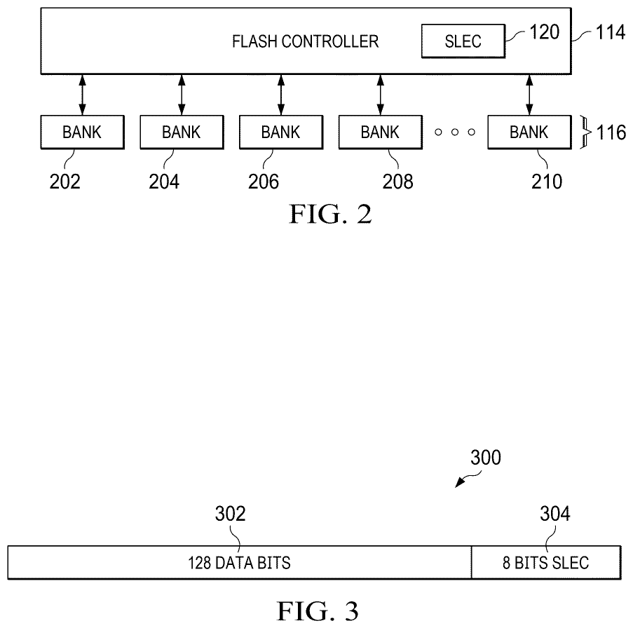

FIG. 2 is an illustration of example flash controller 114, according to various embodiments. In the present example, the flash memory 116 includes multiple banks 202-210. Although the present illustration shows only five banks 202-210, it is understood that the scope of implementations may include any appropriate number of banks.

Each of the banks 202-210 includes memory bit cells arranged in columns and rows, where a single word may correspond to a single row. Each row may also be wide enough to accommodate additional bits, which may be programmed by the SLEC hardware 120 logic.

Each of the banks 202-210 may include hardware to perform read, write, and erase operations. For instance, each of the banks 202-210 may include (not shown) drivers, word lines, bit lines, sense amplifiers, latches, and the like. The flash controller 114 includes logic to perform low-level control of read, write, and erase operations for data in the banks 202-210.

In this example, SLEC hardware logic 120 is implemented using hardware. For instance, although not shown explicitly, the hardware may include a multitude of Boolean logic gates implemented to program SLEC bits. However, the functionality of SLEC hardware logic 120 may be implemented in any appropriate manner, including using firmware in other examples.

FIG. 3 is an illustration of an example row 300, which may be implemented in one of the banks 202-210 of the example of FIG. 2. The flash controller 114 may read from and write to the row 300. In this particular example, the row 300 includes 128 data bits, which correspond to a word. However, the scope of implementations is not limited to 128-bit words. Rather, the scope of implementations may be adapted for words having 32-bits, 64-bits, 256-bits, or the like. The data word is shown as item 302.

Moreover, the row 300 includes eight SLEC bits 304. The SLEC bits 304 have a quantity that is sufficient to 1) identify a particular position of a bit within word 302 as well as to 2) include some redundancy so that if there is a code with only 1s, it may have a Hamming distance of two between all other codes to address potential single bit flips in the SLEC bits 304.

In one example, a minimum number of bits for SLEC bits 304 may be defined by Equation 1, wherein d is a number of data bits and the word 302, and s is the number of SLEC bits 304. In Equation 1, 2^{s} is the quantity of available codes, and the SLEC bits are also able to identify a particular position (d) and include some redundancy(s) and the all-1s case and the all-0s case (2).

$${2}^{s} \geq d + s + 2 \qquad Eq . ( 1 )$$

In the present example, the SLEC bits 304 only protect against single bit failures within word 302. By contrast, some ECC codes may be used to protect all of the bits within word 302. However, as noted above, ECC codes may be unwieldy due to a requirement of some devices to perform an erase on ECC bits when changing ECC bits. However, various embodiments may include more than one set of SLEC bits 304 to protect against more than one bit failure within word 302. For instance, various embodiments may include multiple SLEC bits 304, each of those sets of SLEC bits being used to protect potentially different bits. A typical failure mode includes only a single slow to erase bit within a given 128-bit word, so that additional sets of SLEC bits may be unneeded.

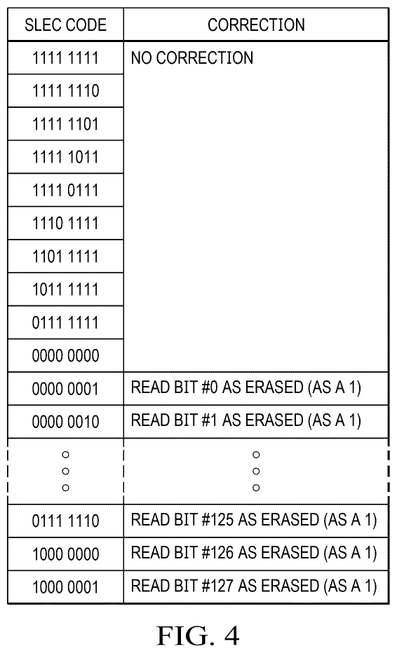

FIG. 4 is a table that provides examples of data that may be stored in SLEC bits 304 of FIG. 3. The top 10 rows of the table may include codes that indicate “no correction”. For instance, one example implementation may use 1111 1111 to indicate no correction is needed within a word subsequent to an erase operation. Also, it is possible that there may be a potential bit flip within the SLEC bits 304. Therefore, the number of bits in this example is chosen to accommodate a Hamming distance of two from the code 1111 1111 of the top row. In other words, any one of those bits within the code 1111 1111 may be mis-stored as a binary zero value, and the flash controller 114 is programmed to read the code as “no correction.” Examples include 1111 1110, 0111 1111, and those codes illustrated therebetween in FIG. 4. Additionally, some embodiments may also use the code having all zeros to indicate no correction subsequent to a program operation. The all-zero code may allow the program operation to turn off SLEC correction by simply performing a program to the SLEC bits for a given word.

The SLEC bits 304 may indicate a position of a particular bit within word 302. For instance, as noted in FIG. 4, 0000 0001 may be used to indicate a bit in the 0th position within the set [0 . . . 127], 0000 0010 may be used to indicate a bit in the 1th position within the set, and on and on until the code 1000 0001, which may be used to indicate the bits in the 127^{th} position.

FIG. 4 does not illustrate the codes that may be used to identify the bits in positions 2-124 within word 302 for ease of illustration. However, a working example is provided as TABLE A following the description of FIG. 8.

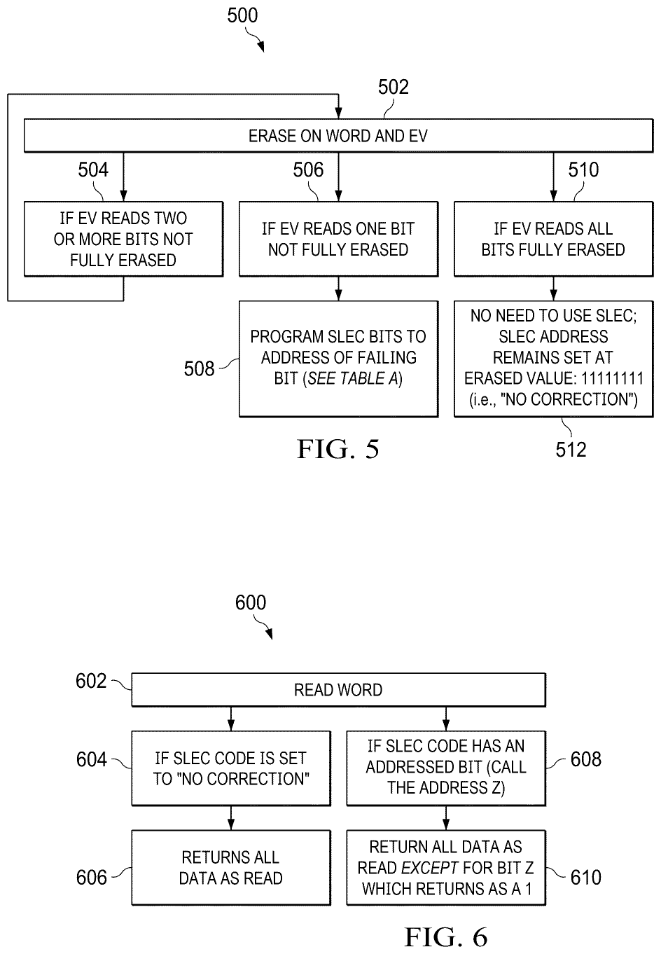

FIG. 5 is an illustration of example method 500, for erasing a word, such as word 302 of FIG. 3, according to various embodiments. Example method 500 may be performed by a memory controller, such as flash controller 114 that includes SLEC hardware logic 120.

At action 502, flash controller 114 performs an erase operation on a word and then performs an erase verification (EV) operation. The erase operation may be included within a sector erase in some embodiments. The EV operation determines whether the erase operation is successful and, if not, identifies particular bits that have failed to erase.

At action 510, the EV operation reads all bits as fully erased. Action 510 is followed by action 512, in which the flash controller 114 may write a code corresponding to “no correction” within SLEC bits or may simply allow SLEC bits to remain at a “no correction” code.

At action 504, the EV operation determines that two or more bits are not fully erased. In response, the flash controller 114 may then repeat the erase operation and EV operation at action 502. Some embodiments may include performing action 502 as many times as it takes to reduce the number of un-erased bits to one. However, other embodiments may include a maximum number of erase and EV operations that may be performed, instead, marking the particular word as unusable or using a different correction operation (not shown).

Following actions 504 and 502, if no un-erased bits remain, then flash controller 114 may go to action 510. On the other hand, should a single un-erase bit remain, then flash controller 114 may perform action 506. At action 506, the EV operation reads a single bit that is un-erased. In response at action 508, the flash controller 114 may then program the SLEC bits to indicate a position within the word at which the un-erased bit is located. For instance, the flash controller 114 may then program a code into the SLEC bits, where example codes are described with respect to FIG. 4 and Table A. In this example, the flash controller 114 may perform a byte-level program operation on the SLEC bits without using an erase operation on the SLEC bits.

In one example of method 500, the least significant bits of the word may start as 00100001, and the SLEC bits may start off as 0000 0000. Action 502 may then be performed, and the result of the EV operation may indicate that the least significant bits are 10111001 and the SLEC bits are as a default put to 1111 1111. In other words, the EV operation has revealed three bits in the least significant bits that have failed to erase. At action 504, the flash controller 114 repeats the erase operation and EV operation so that the least significant bits are 11111101. In other words, only one un-erased bit remains. The flash controller 114 then proceeds to action 508 by programming a code 0000 0010 in the SLEC bits to indicate that the bit in position 1 of the set [0 . . . 127] is un-erased and has failed to transition to a binary one state. Of course, the bit positions may be addressed in any appropriate way, such as by using either a big endian or a little endian direction when counting.

The examples above describe an erase operation as setting bits to a binary one state and a program operation as setting bits to a binary zero state; however, the scope of embodiments is not so limited. Rather, other implementations may perform erase operations by setting bits to a binary zero state and may program by setting bits to a binary one state. The principles described herein may be applied in either or both implementations.

FIG. 6 is an illustration of example method 600, for reading a word, such as word 302 of FIG. 3, according to various embodiments. Example method 600 may be performed by a memory controller, such as flash controller 114 that includes SLEC hardware logic 120.

At action 602, the flash controller 114 performs a read operation on the particular word. Action 602 also includes reading the SLEC bits. Assuming that the SLEC code indicates “no correction” at action 604, then the flash controller 114 moves to action 606. Action 606 includes outputting the data consistent with the way that the bit cells store values. For instance, if the word had been completely erased, and then the read operation of action 602 had been performed, then action 606 may include returning all 1s.

On the other hand, action 608 indicates that the SLEC bits identify a bit within the word at an address corresponding to a Zth place in the word. An example is discussed above, where the least significant bits of the word are 11111101, reflecting a single bit cell that incorrectly has a binary zero state. For instance, the sense amplifiers (not shown) of the particular memory bank may output a 0 when read. However, the SLEC hardware logic 120 of the flash controller 114 is configured to cause the flash controller 114 to output a corrected value for the un-erased bit at action 610. Specifically, the logic of the flash controller 114 corrects the value of the un-erased bit to a binary one so that the least significant bits of the output word are 11111111. In this example, the read operation at action 610 outputs a value that is different from the binary state of the un-erased bit cell.

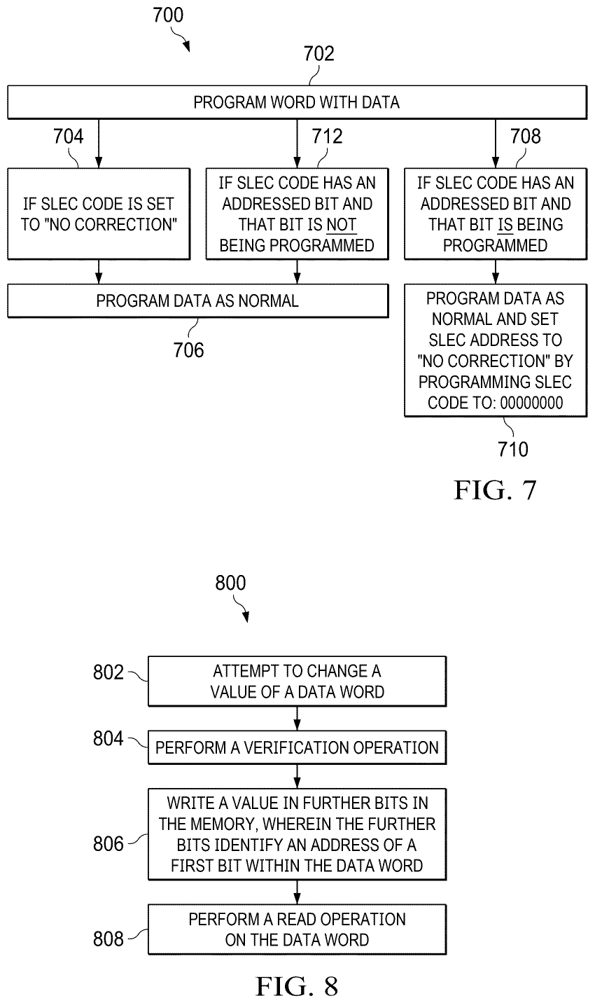

FIG. 7 is an illustration of example method 700, for programming a word, such as word 302 of FIG. 3, according to various embodiments. Example method 700 may be performed by a memory controller, such as flash controller 114 that includes SLEC hardware logic 120.

In one example, the programming includes byte-level programming of both the word and the SLEC bits. Byte-level programming may include writing to bit cells within the word and within the SLEC bits independent of actions performed on other words within the particular memory bank. The byte-level programming of this example may differ from an erase operation, as the byte-level programming is performed on bit cells in a particular row of a memory bank, whereas an erase operation may include erasing an entire sector having multiple rows. Furthermore, in some implementations, program operations may be relatively quick. Therefore, if a bit is slow to program, the flash controller 114 may perform a verification operation to determine that a bit has not changed state and then, in response to the verification operation, perform one or more program operations on the word until the bit is in the desired state.

Method 700 begins with the particular word having been erased. For instance, the word may have previously been subject to an erase operation to set the bits in the word to binary 1s. At action 702, the flash controller 114 programs the word with data. The SLEC bits indicate “no correction” at action 704, so the flash controller 114 programs the data as if each of the bit cells in the word function properly at action 706.

Action 712 illustrates a scenario in which the SLEC code indicates a particular bit within the word. However, the particular bit is not being programmed by the present operation. In one example, the bit cell may be in a binary zero state, and the data to be programmed includes a one for that bit. However, as noted above, the SLEC code is set to identify that bit, which causes that bit to be read out as a one in a subsequent read operation. In such an instance, it may be irrelevant that the bit cell is at a binary zero state because that is consistent with the existing SLEC code. Accordingly, the flash controller 114 programs the data as normal at action 714 and leaves the SLEC code as-is.

For instance, in one example, the bits may have been previously erased, and the least significant bits may be stored as 11111101, and the SLEC code may be 000 0010. The program operation may include writing the least significant bits of the data word as 10101010, where the second to last digit corresponds to the failed bit cell indicated by the SLEC code. The flash controller 114 programs the bits, though the program operation may leave the failed bit as-is. The flash controller 114 leaves the SLEC code as 0000 0010 to indicate that the second to last bit should be read as a binary one.

Action 708 illustrates a scenario in which the SLEC code indicates a particular bit within the word, and that bit is being programmed. For instance, in one example, the word is currently stored as 10101000, and the SLEC bits may be programmed as code 0000 0010 to indicate that the second to last bit cell is slow-to-erase. (This example follows the example of action 712 above.) In other words, the word is programmed to be read out as 10101010. The programming operation of action 710 may write the least significant bits as 10101000, which is inconsistent with the SLEC bits. The program operation writes the least significant bits as 10101000 and then programs the SLEC bits to code 0000 0000 to indicate “no correction.”.

Of course, the actions of method 500, 600, 700 should not be seen in isolation. Rather, a read operation may be performed subsequent to an erase operation or subsequent to a program operation. Furthermore, a program operation may follow a read operation or an erase operation. Also, an erase operation may follow a read operation or a program operation.

In the examples above, the actions of flash controller 114 are illustrated. However, the scope of implementations is not limited to flash controllers and flash memories. Rather, the principles discussed herein may be applied to any nonvolatile RAM technology.

FIG. 8 is an illustration of an example method 800, for correcting a bit in a word, according to various embodiments. Method 800 may be performed by a memory controller, such as flash controller 114 of FIGS. 1-2. More specifically, method 800 may be performed by a memory controller having functionality (e.g., SLEC hardware logic 120) configured to program bits to identify a particular bit within a word.

Action 802 includes attempting to change a value of a data word. An example of a data word includes word 302 of FIG. 3. Action 802 may include an erase operation, such as discussed above with respect to FIG. 5.

Action 804 includes performing a verification operation. A verification operation may be similar to a read operation, and the verification operation may determine whether values are stored to the bits consistent with the erase operation. In one example, a verification operation may indicate that all bits in a word were written correctly. In another example, a verification operation may indicate that one or more bits were not written correctly. For instance, one or more bits may be un-erased in an erase operation.

Action 806 includes writing a value in further bits in the memory. Examples of further bits may include the SLEC bits 304 of FIG. 3. In one example, a program operation programs the word, though the operation programs the failed bit (e.g., the intent of the operation includes changing a status of the bit cell so that the bit cell is inconsistent with a value currently written to the SLEC bits). In this example, action 806 may include programming a code to the SLEC bits to indicate “no correction,” as in action 714.

In yet another example, an erase operation is followed by a verification operation that indicates a failed bit. In such an instance, action 806 may include programming a code to the SLEC bits to identify the particular failed bit, as in action 508.

In an example in which an erase operation results in no failed bits, then the SLEC bits should be all ones, and action 806 may include leaving the erased bits as-is to indicate “no correction.”

Action 808 includes performing a read operation on the data word. For instance, a read operation may include reading both the data word and the SLEC bits. The memory controller does not change the output should the SLEC bits indicate “no correction.” In other words, the output of the read operation may be consistent with the states of the bit cells of the word.

On the other hand, should the read operation include reading a code identifying a particular bit in the word, then the read operation may change a value of that identified bit. As explained above with respect to FIG. 4, the SLEC code may include an address of the particular bit within the data word. The logic of the memory controller may then receive a first value (e.g., 0) for the bit as it is read from the bank and change that bit to a second value (e.g., 1) for the output of the read operation. In fact, the read logic may be programmed to set the bit to a binary one value in response to the SLEC code, regardless of whether the bit is stored as a binary zero or a binary one.

The scope of implementations is not limited to the series of actions of method 800. Rather, method 800 may be modified so that one or more actions are added, omitted, rearranged, or changed. For instance, some implementations may include performing action 802 followed by action 804 multiple times to reduce a number of failed bits to either zero or one. In the case of zero failed bits, the memory controller may program an SLEC code to indicate “no correction.” In the case of a single failed bit, the memory controller may program an SLEC code to identify a particular bit.

Furthermore, method 800 may be performed multiple times, as often as an erase operation or a program operation are performed on a particular word.

Additionally, while the examples above contrast ECC with SLEC, the scope of implementations does not exclude ECC. For instance, ECC may be used in addition to SLEC in some implementations. In one example, an ECC code may be used to protect both the data word and the SLEC bits. In another example, SLEC bits may be used to protect a data word and an ECC code.

TABLE A is an illustration of a particular use case applicable to a 128-bit word and an 8-bit SLEC code. It is understood that the particular SLEC codes used in a particular application may be different based on any number of factors, such as the size of the word. For instance, as illustrated in Equation 1, a larger word may correspond to a larger SLEC code, and a smaller word may correspond to a smaller SLEC code.

TABLE A

| | Address (read this | |
|---|---|---|
| SLEC code | bit as a 1) | Explanation |
| 00000000 | no correction | Used to disable SLEC after a bit |
| | | has been programmed from a 1 to |
| | | a 0: action 710 in FIG. 7 |
| 00000001 | 0 | |
| 00000010 | 1 | |
| 00000011 | 2 | |
| 00000100 | 3 | |
| 00000101 | 4 | |
| 00000110 | 5 | |
| 00000111 | 6 | |
| 00001000 | 7 | |
| 00001001 | 8 | |
| 00001010 | 9 | |
| 00001011 | 10 | |
| 00001100 | 11 | |
| 00001101 | 12 | |
| 00001110 | 13 | |
| 00001111 | 14 | |
| 00010000 | 15 | |
| 00010001 | 16 | |
| 00010010 | 17 | |
| 00010011 | 18 | |
| 00010100 | 19 | |
| 00010101 | 20 | |
| 00010110 | 21 | |
| 00010111 | 22 | |
| 00011000 | 23 | |
| 00011001 | 24 | |
| 00011010 | 25 | |
| 00011011 | 26 | |
| 00011100 | 27 | |
| 00011101 | 28 | |
| 00011110 | 29 | |
| 00011111 | 30 | |
| 00100000 | 31 | |
| 00100001 | 32 | |
| 00100010 | 33 | |
| 00100011 | 34 | |
| 00100100 | 35 | |
| 00100101 | 36 | |
| 00100110 | 37 | |
| 00100111 | 38 | |
| 00101000 | 39 | |
| 00101001 | 40 | |
| 00101010 | 41 | |
| 00101011 | 42 | |
| 00101100 | 43 | |
| 00101101 | 44 | |
| 00101110 | 45 | |
| 00101111 | 46 | |
| 00110000 | 47 | |
| 00110001 | 48 | |
| 00110010 | 49 | |
| 00110011 | 50 | |
| 00110100 | 51 | |
| 00110101 | 52 | |
| 00110110 | 53 | |
| 00110111 | 54 | |
| 00111000 | 55 | |
| 00111001 | 56 | |
| 00111010 | 57 | |
| 00111011 | 58 | |
| 00111100 | 59 | |
| 00111101 | 60 | |
| 00111110 | 61 | |
| 00111111 | 62 | |
| 01000000 | 63 | |
| 01000001 | 64 | |
| 01000010 | 65 | |
| 01000011 | 66 | |
| 01000100 | 67 | |
| 01000101 | 68 | |
| 01000110 | 69 | |
| 01000111 | 70 | |
| 01001000 | 71 | |
| 01001001 | 72 | |
| 01001010 | 73 | |
| 01001011 | 74 | |
| 01001100 | 75 | |
| 01001101 | 76 | |
| 01001110 | 77 | |
| 01001111 | 78 | |
| 01010000 | 79 | |
| 01010001 | 80 | |
| 01010010 | 81 | |
| 01010011 | 82 | |
| 01010100 | 83 | |
| 01010101 | 84 | |
| 01010110 | 85 | |
| 01010111 | 86 | |
| 01011000 | 87 | |
| 01011001 | 88 | |
| 01011010 | 89 | |
| 01011011 | 90 | |
| 01011100 | 91 | |
| 01011101 | 92 | |
| 01011110 | 93 | |
| 01011111 | 94 | |
| 01100000 | 95 | |
| 01100001 | 96 | |
| 01100010 | 97 | |
| 01100011 | 98 | |
| 01100100 | 99 | |
| 01100101 | 100 | |
| 01100110 | 101 | |
| 01100111 | 102 | |
| 01101000 | 103 | |
| 01101001 | 104 | |
| 01101010 | 105 | |
| 01101011 | 106 | |
| 01101100 | 107 | |
| 01101101 | 108 | |
| 01101110 | 109 | |
| 01101111 | 110 | |
| 01110000 | 111 | |
| 01110001 | 112 | |
| 01110010 | 113 | |
| 01110011 | 114 | |
| 01110100 | 115 | |
| 01110101 | 116 | |
| 01110110 | 117 | |
| 01110111 | 118 | |
| 01111000 | 119 | |
| 01111001 | 120 | |
| 01111010 | 121 | |
| 01111011 | 122 | |
| 01111100 | 123 | |
| 01111101 | 124 | |
| 01111110 | 125 | |
| 01111111 | no correction | Hamming distance is 1 from |
| | | erased state; the slow to erased bit |
| | | could exist in the SLEC address |
| | | and should not cause incorrect |
| | | reads |
| 10000000 | 126 | |
| 10000001 | 127 | |
| 10000010 | no correction | Not needed in an example with a |
| | | 128-bit word (same for all |
| | | unmarked below); for larger word |
| | | widths or for a different SLEC |
| | | scheme these codes could be used |
| 10000011 | no correction | |
| 10000100 | no correction | |
| 10000101 | no correction | |
| 10000110 | no correction | |
| 10000111 | no correction | |
| 10001000 | no correction | |
| 10001001 | no correction | |
| 10001010 | no correction | |
| 10001011 | no correction | |
| 10001100 | no correction | |
| 10001101 | no correction | |
| 10001110 | no correction | |
| 10001111 | no correction | |
| 10010000 | no correction | |
| 10010001 | no correction | |
| 10010010 | no correction | |
| 10010011 | no correction | |
| 10010100 | no correction | |
| 10010101 | no correction | |
| 10010110 | no correction | |
| 10010111 | no correction | |
| 10011000 | no correction | |
| 10011001 | no correction | |
| 10011010 | no correction | |
| 10011011 | no correction | |
| 10011100 | no correction | |
| 10011101 | no correction | |
| 10011110 | no correction | |
| 10011111 | no correction | |
| 10100000 | no correction | |
| 10100001 | no correction | |
| 10100010 | no correction | |
| 10100011 | no correction | |
| 10100100 | no correction | |
| 10100101 | no correction | |
| 10100110 | no correction | |
| 10100111 | no correction | |
| 10101000 | no correction | |
| 10101001 | no correction | |
| 10101010 | no correction | |
| 10101011 | no correction | |
| 10101100 | no correction | |
| 10101101 | no correction | |
| 10101110 | no correction | |
| 10101111 | no correction | |
| 10110000 | no correction | |
| 10110001 | no correction | |
| 10110010 | no correction | |
| 10110011 | no correction | |
| 10110100 | no correction | |
| 10110101 | no correction | |
| 10110110 | no correction | |
| 10110111 | no correction | |
| 10111000 | no correction | |
| 10111001 | no correction | |
| 10111010 | no correction | |
| 10111011 | no correction | |
| 10111100 | no correction | |
| 10111101 | no correction | |
| 10111110 | no correction | |
| 10111111 | no correction | Hamming distance is 1 from |
| | | erased state; the slow to erased bit |
| | | could exist in the SLEC address |
| | | and should not cause incorrect |
| | | reads |
| 11000000 | no correction | |
| 11000001 | no correction | |
| 11000010 | no correction | |
| 11000011 | no correction | |
| 11000100 | no correction | |
| 11000101 | no correction | |
| 11000110 | no correction | |
| 11000111 | no correction | |
| 11001000 | no correction | |
| 11001001 | no correction | |
| 11001010 | no correction | |
| 11001011 | no correction | |
| 11001100 | no correction | |
| 11001101 | no correction | |
| 11001110 | no correction | |
| 11001111 | no correction | |
| 11010000 | no correction | |
| 11010001 | no correction | |
| 11010010 | no correction | |
| 11010011 | no correction | |
| 11010100 | no correction | |
| 11010101 | no correction | |
| 11010110 | no correction | |
| 11010111 | no correction | |
| 11011000 | no correction | |
| 11011001 | no correction | |
| 11011010 | no correction | |
| 11011011 | no correction | |
| 11011100 | no correction | |
| 11011101 | no correction | |
| 11011110 | no correction | |
| 11011111 | no correction | Hamming distance is 1 from |
| | | erased state; the slow to erased bit |
| | | could exist in the SLEC address |
| | | and should not cause incorrect |
| | | reads |
| 11100000 | no correction | |
| 11100001 | no correction | |
| 11100010 | no correction | |
| 11100011 | no correction | |
| 11100100 | no correction | |
| 11100101 | no correction | |
| 11100110 | no correction | |
| 11100111 | no correction | |
| 11101000 | no correction | |
| 11101001 | no correction | |
| 11101010 | no correction | |
| 11101011 | no correction | |
| 11101100 | no correction | |
| 11101101 | no correction | |
| 11101110 | no correction | |
| 11101111 | no correction | Hamming distance is 1 from |
| | | erased state; the slow to erased bit |
| | | could exist in the SLEC address |
| | | and should not cause incorrect |
| | | reads |
| 11110000 | no correction | |
| 11110001 | no correction | |
| 11110010 | no correction | |
| 11110011 | no correction | |
| 11110100 | no correction | |
| 11110101 | no correction | |
| 11110110 | no correction | |
| 11110111 | no correction | Hamming distance is 1 from |
| | | erased state; the slow to erased bit |
| | | could exist in the SLEC address |
| | | and should not cause incorrect |
| | | reads |
| 11111000 | no correction | |
| 11111001 | no correction | |
| 11111010 | no correction | |
| 11111011 | no correction | Hamming distance is 1 from |
| | | erased state; the slow to erased bit |
| | | could exist in the SLEC address |
| | | and should not cause incorrect |
| | | reads |
| 11111100 | no correction | |
| 11111101 | no correction | Hamming distance is 1 from |
| | | erased state; the slow to erased bit |
| | | could exist in the SLEC address |
| | | and should not cause incorrect |
| | | reads |
| 11111110 | no correction | Hamming distance is 1 from |
| | | erased state; the slow to erased bit |
| | | could exist in the SLEC address |
| | | and should not cause incorrect |
| | | reads |
| 11111111 | no correction | Erased state for case of no SLEC |
| | | needed; action 512 in FIG. 5 |

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A memory controller configured to:
perform a first operation to change a first value of a data word that is stored in a memory device;
perform a verification operation to determine whether the first operation was successful; and
in response to the verification operation, write a second value in further bits in the memory device, wherein the second value identifies a first bit within the data word associated with an error of the first operation.

2. The memory controller of claim 1, wherein the verification operation is configured to determine that the error of the first operation occurred based upon the first bit not attaining a first digital value.

3. The memory controller of claim 1, wherein the first operation comprises an erase operation of the data word, and wherein the error is associated with the first bit failing to erase.

4. The memory controller of claim 3, wherein the memory controller is further configured to:
subsequent to performing the first operation, determine that multiple bits in the data word have failed to erase; and
perform a first verification operation, previous to the verification operation, resulting in only the first bit having failed to erase.

5. The memory controller of claim 1, wherein a quantity of the further bits is large enough to identify the first bit, to accommodate an all-0s set, and to accommodate an all-1s set having a Hamming distance of 2 between all other values of the further bits.

6. The memory controller of claim 1, wherein the first operation comprises an erase operation directed to the data word to change the data word to all ones, and wherein the verification operation is configured to determine that the first bit has failed to attain a binary one value according to the erase operation.

7. The memory controller of claim 1, wherein the first operation comprises an erase operation, and wherein the memory controller is further configured to:
subsequent to writing the second value, perform a program operation on the data word in which the first bit has a value inconsistent with the second value; and
write a code into the further bits, wherein the code indicates no correction of the data word.

8. The memory controller of claim 1, wherein the first operation comprises an erase operation, and wherein the memory controller is further configured to:
subsequent to writing the second value, perform a program operation on the data word in which the first bit has a value consistent with the program operation; and
maintain the second value in the further bits.

9. The memory controller of claim 1, wherein the memory controller is further configured to:
change the second value in the further bits according to a byte-level program operation.

10. The memory controller of claim 1, wherein the memory controller is further configured to:
read the data word and the second value in the further bits; and
output a data value of the data word, wherein the data value includes a binary state of the first bit different than the binary state of the first bit as stored in the memory device.

11. The memory controller of claim 1, wherein the memory controller is further configured to:
read the data word and the second value in the further bits; and
correct the first bit, according to the second value in the further bits, thereby outputting a corrected data word.

12. The memory controller of claim 1, wherein the memory controller is configured as a flash memory controller, and wherein the memory controller further includes hardware logic configured to write the second value.

13. A computing device comprising:
a processor core;
a memory device, coupled to the processor core, and configured to store a plurality of data words;
a memory controller, coupled to the memory device and the processor core, and configured to perform read, write, and erase operations with respect to the memory device and under control of the processor core, further wherein the memory controller is configured to:
perform an erase operation on a first data word of the plurality of data words;
determine that a first bit within the first data word has not erased; and
program additional bits of the memory device to identify the first bit.

14. The computing device of claim 13, wherein the memory controller, to determine that the first bit has not erased, is configured to:
perform a verify operation on the first data word, wherein the verify operation is configured to identify individual ones of the bits in the first data word that have not erased; and
perform a further erase operation and a further verify operation, resulting in only the first bit having not been erased.

15. The computing device of claim 13, wherein the memory controller is further configured to:
subsequent to programming the additional bits, perform a first byte-level program operation on the first data word; and
perform a second byte-level program operation on the additional bits without erasing the additional bits.

16. The computing device of claim 13, wherein the memory controller is further configured to:
subsequent to programming the additional bits, read the first data word and the additional bits from the memory device; and
output a corrected data word corresponding to the first data word, wherein the first bit is corrected according to the additional bits.

17. The computing device of claim 13, wherein the memory controller is further configured to:
program the additional bits in a same row of the memory device as the first data word.

18. A method comprising:
programming a first value into a data word in a memory device, wherein the first value overwrites a second value, further wherein the second value includes a first bit, and wherein additional bits in the memory device identify an address within the data word of the first bit;
determining whether the first value is consistent with the additional bits; and
either programming the additional bits or not programming the additional bits based at least in part on the determining.

19. The method of claim 18, comprising:
not programming the additional bits in response to determining that the first value is consistent with the additional bits.

20. The method of claim 18, comprising:
programming the additional bits to indicate no correction in response to determining that the first value is inconsistent with the additional bits.
